(19) United States
(12) Patent Application Publication
(10) Pub. No.: US 2009/0111444 A1
(43) Pub. Date: Apr. 30, 2009

(54) SOUND IN A CONFERENCE COMMUNICATION SESSION

(75) Inventor: Jari SASSI, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/181,704

(22) Filed: Jul. 29, 2008

Related U.S. Application Data
(60) Provisional application No. 60/991,463, filed on Nov. 30, 2007.

(30) Foreign Application Priority Data
Oct. 31, 2007 (EP) 07119768.5

(51) Int. Cl. H04M 3/42

(52) U.S. Cl. 455/416

(57) ABSTRACT

According to the present invention a first main communication device at a first site includes a first network interface associated with a communication network, a local wireless interface for interfacing with a number of satellite communication devices, a network communication unit for communicating over the first network interface, a local communication unit for communication with satellite communication devices via the local wireless interface, and a control unit. The control unit receives sound picked up by a group of satellite communication devices at the first site via the local wireless interface, combines this received sound, and orders the network communication unit to send the combined sound via the network interface to a second main communication device at a second site as sound in the conference communication session provided by the first main communication device.

### CROSS REFERENCE TO RELATED APPLICATION

This application claims priority under 35 U.S.C. §119 based on U.S. provisional application No. 60/991,463, filed Nov. 30, 2007, the disclosure of which is hereby incorporated by reference herein in its entirety.

### TECHNICAL FIELD OF THE INVENTION

The present invention relates generally to the field of conference communication sessions over communication networks and, more particularly, to a method, a communication device, and a computer program product for conference communication via a communication network between the communication device provided at a first site and at least one other communication device provided at a second site.

### DESCRIPTION OF RELATED ART

Conference communication equipment, such as conference phones, typically includes a telephone equipped with one or more speakers and often having one or more microphones. When such conference equipment is to be put in use, the microphones may then be placed on a table at a first site to record the sound from conference participants or conferees at the first site, which typically involves the participants sitting around the table and the stationary microphones. They thus sit at various distances to such microphones and therefore the sound being picked up may vary considerably from participant to participant, for example, depending on a conferee's distance from a microphone.

Under the above circumstances, it may be difficult to pick up the sound clearly from each of the participants at the first site, which means that the conferees at the second site, communicating with the first site over the communication network, may have difficulties in hearing what is being said. This can lead to misunderstandings and reduce the efficiency of such conferences, which may be highly undesirable.

There is therefore a need for improving on this situation.

### SUMMARY OF THE INVENTION

The present invention is directed to providing improved sound quality from a first site to a second site in a conference communication session.

Embodiments of present invention may provide improved communications by realizing the possibilities that exist in the cellular phone field, in which network communication devices are often provided with short range communication abilities. In this field, accessories to such devices may also be provided with short range communication abilities. Phones, as well as many such accessories, are also provided with sound receiving capabilities. According to the present invention, such capability may be put to use in improving the sound transmitted in a conference communication session from one site to another.

A first aspect of the present invention provides a method of engaging in a conference communication session via a communication network between a first main communication device provided in a first site and at least one second main communication device provided in a second site comprising the steps of: receiving, in the first main communication device, sound picked up by a group of satellite communication devices at the first site via a local wireless interface, combining this received sound, and sending the combined sound to the at least one second main communication device via the network as sound in the communication session provided by the first main communication device.

A second aspect of the present invention includes the features of the first aspect, further comprising sending an invitation to join the conference communication session to satellite communication devices that are within range of the local wireless interface, receiving an acceptance from a number of satellite communication devices via the local wireless interface and forming the group of satellite communication devices from satellite communication devices that have accepted the invitation.

A third aspect of the present invention includes the features of the second aspect, wherein the acceptance includes a key and further comprising comparing the received key with a conference key and forming the group only of satellite communication devices that have sent a key matching the conference key.

A fourth aspect of the present invention includes the features of the first aspect, further comprising distributing, from the first main communication device, sound received from the second main communication device in the conference communication session to the group of satellite communication devices via the local wireless interface.

A fifth aspect of the present invention includes the features of the first aspect, further comprising only combining sound from a communication device at the first site during a time interval in the conference communication session where sound above a sound pressure level threshold is picked up by the communication device.

A sixth aspect of the present invention includes the features of the first aspect, further comprising receiving speech indicators from satellite communication devices at the first site and only combining sound from satellite communication devices during a time interval in the conference communication session for which a corresponding speech indicator has been received.

A seventh aspect of the present invention includes the features of the first aspect, further comprising receiving pieces of attendant specifying data from the group of satellite communication devices, forming a set of attendant specifying data including pieces of received attendant specifying data and sending the set of attendant specifying data to the second main communication device via the network.

An eighth aspect of the present invention includes the features of the seventh aspect, wherein the set of attendant specifying data also includes a piece of attendant specifying data associated with the first main communication device.

A ninth aspect of the present invention includes the features of the seventh aspect, wherein a piece of attendant specifying data is an identity of the communication device associated with the local wireless interface.

A tenth aspect of the present invention includes the features of the seventh aspect, wherein a piece of attendant specifying data is an electronic business card associated with a corresponding communication device.

An eleventh aspect of the present invention includes the features of the first aspect, wherein the step of combining also includes combining the received sound with sound picked up by the first main communication device.

A twelfth aspect of the present invention concerns first main communication device provided in a first site for engaging, via a communication network, in a conference communication session with at least one second main communication device provided in a second site comprising: a first network interface associated with the communication network, a local wireless interface for interfacing with a number of satellite communication devices, a network communication unit for communicating over the first network interface, a local communication unit for communication with satellite communication devices via the local wireless interface, and a control unit configured to receive sound picked up by a group of satellite communication devices at the first site via the local wireless interface, combine this received sound, and order the network communication unit to send the combined sound via the network interface to the at least one second main communication device as sound in the conference communication session provided by the first main communication device.

A thirteenth aspect of the present invention includes the features of the twelfth aspect, wherein the control unit is further configured to send an invitation to join the conference communication session to satellite communication devices that are within range of the local wireless interface, receive an acceptance from a number of satellite communication devices via the local wireless interface and form the group of satellite communication devices from satellite communication devices that have accepted the invitation.

An fourteenth aspect of the present invention includes the features of the thirteenth aspect, wherein the acceptance includes a key and the control unit is further configured to compare the received key with a conference key and form the group only of satellite communication devices that have sent a key matching the conference key.

A fifteenth aspect of the present invention includes the features of the twelfth aspect, wherein the control unit is further configured to distribute sound received from the second main communication device in the conference communication session to the group of satellite communication devices via the local wireless interface.

A sixteenth aspect of the present invention includes the features of the twelfth aspect, wherein the control unit is further configured to only combine sound from a communication device at the first site during a time interval in the conference communication session where sound above a sound pressure level threshold is picked up by the communication device.

A seventeenth aspect of the present invention includes the features of the twelfth aspect, wherein the control unit is further configured to receive speech indicators from satellite communication devices at the first site and to only combine sound from satellite communication devices during a time interval in the conference communication session for which a corresponding speech indicator has been received.

An eighteenth aspect of the present invention includes the features of the twelfth aspect, wherein the control unit is further configured to receive pieces of attendant specifying data from the group of satellite communication devices, form a set of attendant specifying data including pieces of received attendant specifying data and send the set of attendant specifying data to the second main communication device via the network interface.

A nineteenth aspect of the present invention includes the features of the eighteenth aspect, wherein a piece of attendant specifying data is an identity of the communication device associated with the local wireless interface.

A twentieth aspect of the present invention includes the features of the eighteenth aspect, wherein a piece of attendant specifying data is an electronic business card associated with a corresponding communication device.

A twenty-first aspect of the present invention includes the features of the twelfth aspect, further comprising a sound pick-up unit and where the control unit when being configured to combine sound is configured to combine the received sound with sound picked up by the sound pick up unit.

A twenty-second aspect of the present invention includes the features of the twelfth aspect, wherein it is a portable communication device.

A twenty-third aspect of the present invention includes the features of the twenty-second aspect, wherein it is a wireless communication device.

A twenty-fourth aspect of the present invention includes the features of the twenty-third aspect, wherein it is cellular phone.

A twenty-fifth aspect of the present invention concerns a computer program product for engaging in a conference communication session via a communication network between a first main communication device provided in a first site and at least one second main communication device provided in a second site and comprising: computer program code on a computer readable medium, configured to make the first main communication device perform, when the program code is loaded in the first main communication device, receive sound picked up by a group of satellite communication devices at the first site via a local wireless interface, combine this received sound, and order the sending of the combined sound to the at least one second main communication device via the network as sound in the conference communication session provided by the first main communication device.

Embodiments if the invention may provide various advantages. For example, it may be possible to combine and transfer sound from the various satellite communication devices. This sound may have a better quality than the sound picked up by a central microphone of the first main communication device, since microphones of the satellite communication devices may be held closer to the mouths of their users. This enables conferees at the second site to better hear what is being said at the first site. The invention can furthermore be provided without special conference equipment. It can use existing cellular phone technology. The units that are required for implementing the present invention normally exist in today's cellular phones and accessories to such phones. Therefore, additional costs for implementing the present invention are minimal.

It should be emphasized that the term “comprises/comprising” when used in this specification is taken to specify the presence of stated features, steps or components, but does not preclude the presence or addition of one or more other features, steps, components or groups thereof.

### BRIEF DESCRIPTION OF THE DRAWINGS

The present invention will now be described in more detail in relation to the enclosed drawings, in which:

FIG. 1 schematically shows a number of satellite communication devices communicating with a first main communication device at a first site, which first main communication device is in turn communicating with a second main communication device at a second site via a communication network;

FIG. 2 shows a front view of a first main communication device according to the present invention in the form of a cellular phone;

FIG. 3 shows a block schematic of the relevant parts of the first main communication device and a satellite communication device;

FIG. 4 shows a flow chart of a number of method steps taken in a method according to the present invention for engaging in a conference communication session between the first main communication device and the second main communication device;

FIG. 5 shows a flow chart of a number of further method steps taken in a method according to the present invention for engaging in the conference communication session between the first main communication device and the second main communication device; and

FIG. 6 shows a CD ROM disc on which program code for executing a method according to the present invention is provided.

### DETAILED DESCRIPTION OF EMBODIMENTS

The present invention is directed to providing a better quality of sound transmitted from a first site to a second site in a conference communication session.

Such sessions may being established via a communication network, which may include a computer network (e.g., using VoiP), a PSTN network, a wireless network, or any other suitable network over which conference communication sessions transmitting and receiving audio data can be conducted.

In an exemplifying description of the present invention this network will be a wireless wide area network (WAN), for example, a GSM network, a GPRS network, a CDMA network, a UMTS network, an LTE network, or other network. These are merely examples of networks where the present invention may be implemented. Thus, other communication networks can be used according to the principles of the present invention.

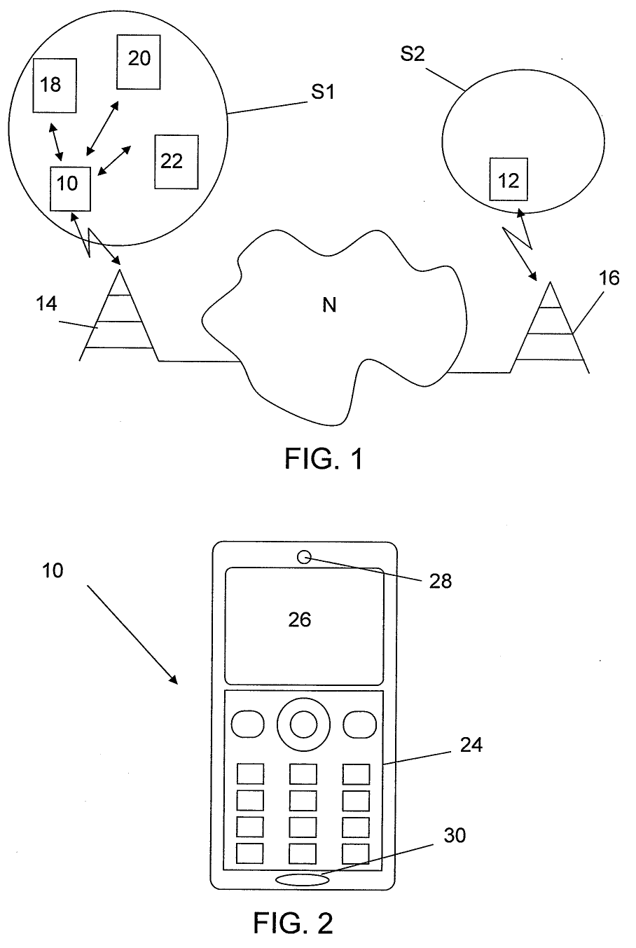

FIG. 1 schematically depicts a first main communication device 10 at a first site S1 communicating with a second main communication device 12 at a second site S2 via a communication network N. In the example given here, first and second main communication devices 10, 12 are cellular phones or devices having cellular phone capabilities, where first and second main communication devices 10, 12 communicate with each other via base stations 14 and 16 provided in network N. First and second main communication devices 10, 12 are here involved in a conference communication session including audio transmission.

First main communication device 10 may furthermore be equipped with a local wireless interface for communication according to a local wireless communication protocol, which may be a short-range communication protocol for directly interfacing with other devices, like Bluetooth®. However, the invention is not limited to Bluetooth®, but other techniques can be used, such as WLAN. Via this local wireless interface, first main communication device 10 may be communicating with a first, a second, and a third satellite communication device 18, 20, 22 at first site S1. The users of satellite communication devices 18, 20, 22, as well as a user of first main communication device 10, may be participating in the conference communication session. It should here be appreciated that also second main communication device 12 may in a similar manner be communicating with satellite communication devices. However, this is by no means a requirement.

First main communication device 10 may be, in this example, a wireless communication device and more particularly a portable communication device. In one embodiment, first main communication device 10 is a cellular phone. Such a device is shown in a front view in FIG. 2. Phone 10 may include a display 26 and a user input unit, for example, in the form of a keypad 24 including a number of keys. Phone 10 may include a speaker 28 and a sound pick up unit, for example, in the form of a microphone 30. It should here be appreciated that the phone 10 may, as an alternative, be a special conference device placed on a table and provided with one or more peripheral devices, for example, a microphone and one or more (e.g., large) speakers. It is also possible that a cellular phone is connected to an external speaker, for instance, via a system connector, to provide a better loudspeaker than the one provided in phone 10.

Keypad 24 may be used for entering information such as selecting of functions and/or responding to prompts, and display 26 may be used to display functions and/or prompts to a user of phone 10. As is indicated above, a cellular phone is just one example of a communication device in which the invention may be implemented. The invention can, for instance, also be used in other portable communication devices, such as in a PDA (personal digital assistant), a palm top computer or a laptop computer, by which the device has ability to communicate via network N. The device may also be a regular fixed phone connected to a PSTN.

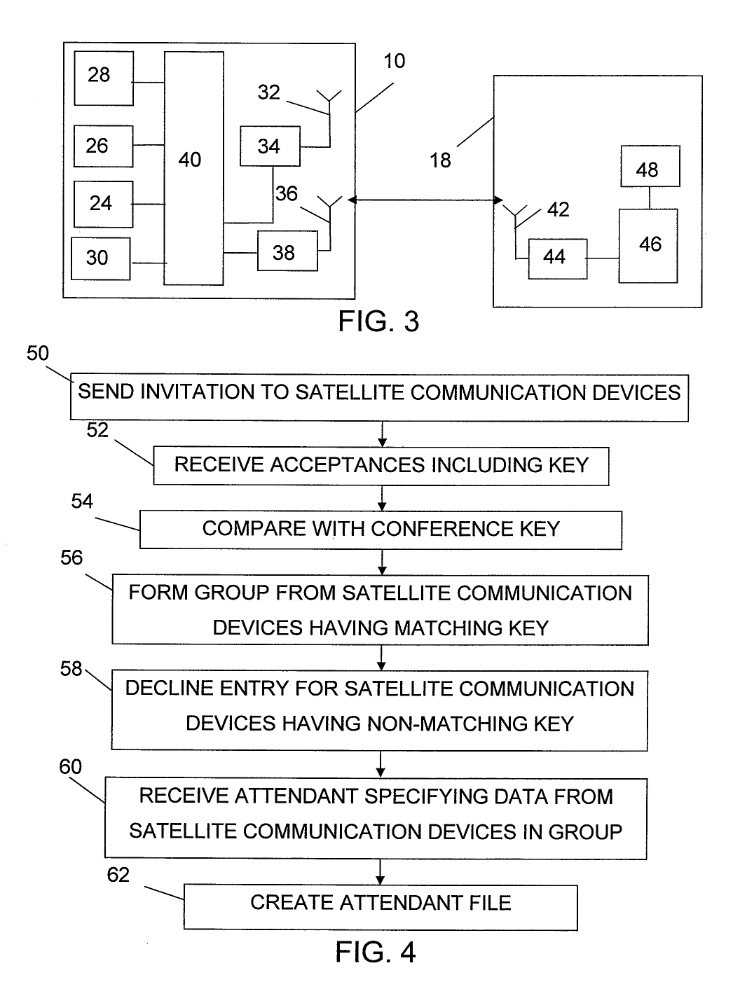

FIG. 3 shows a block schematic of first main communication device 10 when communicating with first satellite communication device 18. First main communication device 10 may include above-described keypad 24, display 26, speaker 28, and/or microphone 30, each of which may connect to a first control unit 40. First control unit 40 may, in turn, connect to a network communication unit 34 and to a first local communication unit 38. Network communication unit 34 may, in turn, connect to a wireless network interface in the form of a first antenna 32, and first local communication unit 38 may, in turn, connect to a first local wireless interface 36 for communication with other wireless communication devices locally at first site S1, of which first satellite communication device 18 may be one.

Local wireless interface 36 may be an antenna. In this example, the communication may furthermore be a direct local communication. Network communication unit 34 may be a radio communication unit, for instance, in the form of an ASIC circuit comprising functionality for communication in (wireless WAN) network N, such as modulators, demodulators, power amplifiers, etc. Local communication unit 38 is in one variation of the present invention, an interface for directly interfacing with other communication devices at the first site. Local communication unit 38 may be a local wireless communication unit. For example, local communication unit 38 may be a Bluetooth® communication unit and local wireless interface 36 may thus be a Bluetooth® antenna.

Similarly, first satellite communication device 18 may include a second control unit 46 that connects to a second local communication unit 44, which in turn may connect to a second local wireless interface 42 for communication with first main communication device 10. Also, second local communication unit 44 may be a Bluetooth® communication unit and second local wireless interface 42 may thus be a Bluetooth® antenna.

Here, first satellite communication device 18 may include a sound pick up unit in the form of a microphone 48 connected to second control unit 46. First satellite communication device 18 may also include user input units in the form of a keypad and/or buttons and a display, as well as head phones and/or speakers. First satellite communication device 18 may be another cellular phone. However, it should be appreciated that it can be another type of device as well, such as a head set or a hands-free device. These are typical accessories which are able to communicate with cellular phones.

Now, a first part of the present invention will be described with reference being made to previously-described FIGS. 1-3, as well as to FIG. 4, which shows a flow chart of a first number of method acts taken in a method according to the present invention for engaging in a conference communication session between first main communication device 10 and second main communication device 12.

An exemplary method may begin with a user of first main communication device 10 at first site S1 wanting to conduct a conference communication session with second main communication device 12 at second site S2. Establishing such a session from first site S1 may be controlled by first control unit 40, which may be provided as a part of an ordinary phone communication function in first main communication device 10. First control unit 40 may receive a selection to start a conference communication session from the user of first communication device 10 via keypad 24 and/or may receive a phone call from second main communication device 12. Under such circumstances, first control unit 40 may ask the user, using display 26, if any other persons are to join the conference at first site S1, and may receive a selection by the user, via keypad 24, that others are to be invited. First control unit 40 may then order local communication unit 38 to send out an invitation to join the conference via second antenna 36 (step 50). The invitation may be sent to all satellite or peripheral communication devices at first site S1, which may include an area that second antenna 36 covers.

Thereafter, first control unit 40 may await reception of one or more acceptances. The invitation may be, for instance, received by second control unit 46 of first satellite communication device 18 via third antenna 42, and second local communication unit 44. The invitation may thus be sent out to all persons having a satellite communication device being in an operating range of coverage for second antenna 36, which may be when such a person is in a conference room and/or is entering a conference room. The invitation may then be presented by second control unit 46 to the user of first satellite communication device 18 via a display (not shown). As one or more satellite communication devices accept to join the conference (which may be done through their satellite communication devices pairing with first main communication device 10), they may send acceptances. An acceptance may, for example, include a key, which a user of a satellite communication device may have to enter via a button, a keypad, and/or other suitable input means.

Thus, second control unit 46 may receive an indication from the associated user of first satellite communication device 18 that the user wants to join the conference. This indication may, for example, be accompanied by a key, which key may have been provided orally from the user of first main communication device 10 and/or in another suitable secure manner to the user of first satellite communication device 18. Second control unit 46 may then send an acceptance including the key to first local communication unit 38 of first main communication device 10 via second and third antennas 36, 42, and second local communication unit 44.

When first local communication unit 38 receives acceptances and associated keys from satellite communication devices within range, it may forwards the acceptances and/or keys to, for example, first control unit 40. First control unit 40 thereafter may compare the received keys with a conference key (step 54). Of all the devices that have accepted to join the conference, first control unit 40 may then form a group of satellite communication devices, which group is constituted by those that have provided the correct key, i.e., a key that matches conference key (step 56). As an example, first, second, and third satellite communication devices 18, 20, 22 have here all provided the correct key. Any possible other satellite communication devices that have provided the wrong key, i.e., a non-matching key, may be denied entry into the session (step 58). First control unit 40 may thus, under these circumstances, order first local communication unit 38 to send a decline message via second antenna 36. Thereafter, first control unit 40 may receive pieces of attendant specifying data from all satellite communication devices in the group (step 60), and form a set of attendant specifying data, here in the form of an attendant file (step 62), based on this received attendant specifying data.

Attendant specifying data may, for example, be requested and received via first local wireless interface 38. A piece of attendant specifying data may in its simplest form be an identity associated with the local wireless interface and local communication unit of the satellite communication device. Using, for instance, Bluetooth®, it is possible for a user to provide such a piece of attendant specifying data through naming the device for this communication. This name may thus constitute the piece of attendant specifying data. Under circumstances in which satellite communication devices are cellular phones, the attendant specifying data can be contact information provided in relation to the satellite communication device. This may be, for instance, an electronic business card, a so-called VCARD, which may include data about the user of the satellite communication device, like name, address, title, and employer, as well as an image of this user. It is here also possible that attendant specifying data is not requested by first control unit 40, but is received automatically, particularly if the device name is used. In the attendant file that is created also the corresponding attendant specifying data associated with main communication device 10 may be included, which may thus be the device name or an electronic business card associated with the user of first main communication device 10.

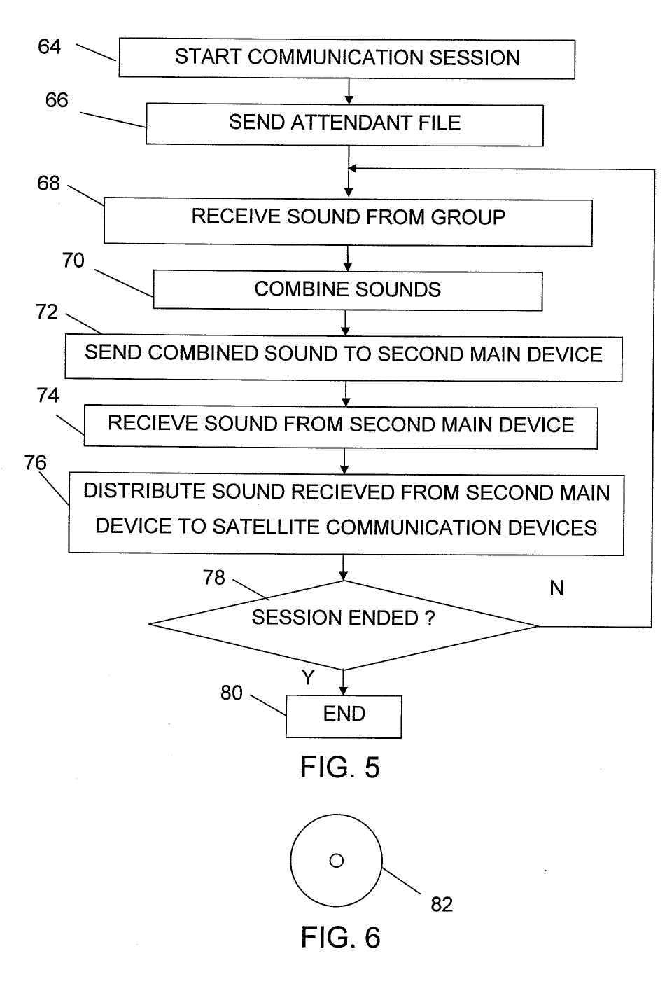

When this has been accomplished, it is now possible for each of the users of the satellite communication devices in the group, as well as the user of first main communication device 10 at first site S1, to engage in a conference communication session with corresponding conferees amassed at second site S2 communicating using second main communication device 12. Another feature of the present invention outlining how this may be performed will now be described with reference also being made to FIG. 5, which shows a flow chart of a number of further method steps taken in a method according to the present invention for establishing conference communication session between first main communication device 10 and second main communication device 12.

The conference communication session may commence (step 64). When the conference communication session is initiated by first main communication device 10, control unit 40 here may then order network communication unit 34 to place a call to second main communication device 12 via network N. When the conference communication session is initiated by second main communication device 12, a call from that device may here be accepted by first control unit 40. For this conference communication session, sound (audio packets) may be exchanged over network N between first and second main communication devices 10, 12. In this session, the attendant file may furthermore be sent from first control unit 40 of first main communication device 10 to second main communication device 12 using network communication unit 34 and first antenna 32 (step 66).

This file may be sent before sound is being transmitted and/or while sound is being sent. Depending on the type of network involved, the file may be transferred in various ways. In case of a GSM network, it may be provided in a message such as an SMS, while for other types of networks it may be sent as a data message in the session or as a data message transferred separate from the conference communication session. In this manner, it is possible for second main communication device 12 to present audio associated with the attendants at first site S1 to the attendants at second site S2. As mentioned above, communications (e.g., audio data) may be transferred. In such transfer, the microphones of the satellite communication devices at first site S1 pick up sound from their respective users. This sound is, when first satellite communication device 18 is taken as an example, transferred from microphone 48 to second local communication unit 44 under the control of second control unit 46. From there, the sound may be transferred to first control unit 40 of first main communication device 10, via antennas 36, 42 and first local communication unit 40. In first main communication device 10 also microphone 30 may pick up sound, which may be transferred to first control unit 40. In this manner, first control unit 40 receives sound from the group (step 68).

All these various sounds may then be combined in first control unit 40 (step 70), and then sent to second main communication device 12 using network communication unit 34 and first antenna 32. There may thus be one connection from first main communication device 10 at first site S I to second main communication device 12 at second site S2, over which connection the combined sounds from first main communication device and all the satellite communication devices in the first group may be sent. This combined sound may thus be sent as the sound in the conference communication session that is hosted by first main communication device 10.

There may furthermore be a second connection from second main communication device 12 to first main communication device 10, which includes the sound picked up at second site S2. The sound from second site S2 may thus be received by first control unit 40 via first antenna 32 and network communication unit 34 (step 74). This sound may then be distributed by first control unit 40 to satellite communication devices 18, 20, and 22 of the group via first local communication unit 38 and second antenna 36 (step 76). A satellite communication device, such as device 18, may then receive the distributed sound via third antenna 42 and second local communication unit 44. This received sound is then sent to a speaker of the satellite communication device 18 under the control of second control unit 46.

First control unit 40 may continually investigate whether a current session has ended. If not (step 78), sound is continued to be received from the group (step 68), combined (step 70), and sent to second main communication device 12 (step 72). Sound received from second main communication device 12 (step 74), is also distributed to the satellite communication devices (step 76). If, however, the session has, in fact, ended (step 78), the method completes through ending the connection over network N (step 80).

In this way, it is possible to combine and transfer audio data from the various satellite communication devices. The presented sound will have superior quality to sound picked up by a centrally located, stationary microphone of first main communication device 10, since the microphones of the satellite communication devices may be displaceably disposed closer and directed to the source of the sound, e.g., the mouths of the conferees. This enables the conference attendees at a remote, receiving conference site to more clearly hear what is being said at the originating site. By using a technology, like Bluetooth®, it is furthermore possible to have as many as ten to fifteen, or more satellite communication devices participating in the above described way. A cellular phone in this way becomes a conference-enabling device that uses satellite communication devices as microphones. There is no need for special conferencing equipment. Since the units that are required for implementing the present invention normally exist in today's cellular phones and accessories to such phones, the additional costs for implementing the present invention are minimal.

In many communication devices, such as cellular phones, noise is added to the sound being picked up by a microphone. This is done in order for a receiving party to understand that the connection has not been broken even though there is silence. However, when sound is aggregated in the above-described manner, there is a potential that also the additional noise is being combined, which may lead to a high noise level, especially when there are many satellite communication devices participating in the communication.

According to some variations of the present invention, the sound from conferees that are not the primary speakers is muted. This can be done through only combining sound from a particular device during a time interval in the conference communication session when the subject user is actually speaking. This can be achieved by a satellite communication device, or the control unit of the first main communication device, if the sound picked up by the microphone of the satellite communication device in question is above a sound pressure level threshold. If the sound is below the threshold the sound picked up by a satellite communication device will not be combined, which results in a lowering of the noise level of the transmitted sound. This principle may of course also be applied to the sound being picked up by the microphone of the first main communication device.

As an alternative it is possible that the control unit of a satellite communication device generates a first speech indicator. Such a first speech indicator can be automatically generated based on the above described sound pressure level being exceeded. It is also possible that such a first speech indicator is generated by the user of the satellite communication device through pressing on a button and/or a key. The first speech indicator is in this case transferred from the satellite communication device to the first main communication device, the control unit of which then only includes the sound associated with such a first speech indicator in the combining during a time interval associated with this first speech indicator. A first speech indicator may be followed by a silence indicator, which may also be automatically generated when the sound pressure level being picked up falls below the above-mentioned threshold or when the user actuates a button and/or a key. The sound from a particular satellite communication device is then only being combined during a time interval in the conference communication session for which a corresponding speech indicator has been received. This principle may of course also here be applied to the sound being picked up by the microphone of the first main communication device.

The control units in the communication devices according to the present invention may be provided, for example, in the form of one or more processors with corresponding memory containing the program code for performing their functions. This program code can also be provided on one or more computer program products such as a computer-readable medium like a CD ROM disc 82 as depicted in FIG. 6, which will perform their functions when loaded into a communication device having suitable processing capabilities. Naturally, other types of computer-readable media can be provided for this, like, for instance, a removable memory, such as a memory stick. The computer program product can also be provided as software, which may be downloaded remotely from a server either outside or inside the cellular network and/or be downloaded via a computer like a PC to which the main communication device is temporarily connected.

A number of further variations can be made to the present invention in addition to those already mentioned. For example, the provision of a key by a satellite communication device and a comparison with a conference key may be omitted. Also, the provision of attendant-specifying data may be omitted. The sound from the remote site need furthermore not be provided to the satellite communication devices of the first site, but can instead be emitted through a speaker associated with the first main communication device. It is also possible to receive an attendant file from the remote site and distribute it to the satellite communication devices of the first site or provide it only through a display associated with the first main communication device.

In relation to muting of communication devices at the first site it is possible that the first control unit keeps track of from which communication device sound in a given time interval is being combined and generates a second speech indicator, which second speech indicator would point to a piece of attendant-specifying data in the attendant file. This second speech indicator can then be transferred to the second main communication device as the sound associated with this piece of attendant-specifying data is being sent to the second main communication device. The second main communication device may then present an indication of which of the conference attendants being provided in the attendant file that is speaking. This can be accomplished, for example, through providing additional information in relation to a piece of attendant-specifying data, for instance, through highlighting a name in a group of names presented on a screen or display. It is also possible that any sound picked up by the first main communication device is not being part of the combining being performed, but that this device is only involved in the control of the conference communication session.

The conference communication session was above described in relation to sound. It is also possible that the conference communication session includes images and then perhaps video images. In this case, it is furthermore possible to receive video images from the satellite communication devices and apply the same principles of combining that were used in relation to sound pressure level thresholds and/or first speech indicators. In this scenario, only images associated with one first speech indicator or sound pressure level threshold being exceeded may be provided in the first connection between the first and second main communication devices in a given time interval.

In the description that was made above there were only two sites involved in the conference communication session. It should be appreciated that it is also possible with more sites being engaged in the session.

There are countless other possible variations that can be made to the present invention that have not been described here. Therefore the present invention is only to be limited by the accompanying claims.

What is claimed is:

1. A method for engaging in a conference communication session via a communication network between a first main communication device provided in a first site and at least one second main communication device provided in a second site comprising:
receiving, in said first main communication device, sound picked up by a group of satellite communication devices at said first site via a local wireless interface;
combining this received sound; and
sending the combined sound to the at least one second main communication device via the network as sound in the communication session provided by the first main communication device.

2. The method of claim 1, further comprising sending an invitation to join the conference communication session to satellite communication devices that are within range of the local wireless interface, receiving an acceptance from a number of satellite communication devices via the local wireless interface and forming said group of satellite communication devices from satellite communication devices that have accepted the invitation.

3. The method of claim 2, wherein the acceptance includes a key and further comprising comparing the received key with a conference key and forming said group only of satellite communication devices that have sent a key matching the conference key.

4. The method of claim 1, further comprising distributing, from the first main communication device, sound received from the second main communication device in the conference communication session to the group of satellite communication devices via the local wireless interface.

5. The method of claim 1, further comprising only combining sound from a communication device at the first site during a time interval in the conference communication session where sound above a sound pressure level threshold is picked up by said communication device.

6. The method of claim 1, further comprising receiving speech indicators from satellite communication devices at the first site and only combining sound from satellite communication devices during a time interval in the conference communication session for which a corresponding speech indicator has been received.

7. The method of claim 1, further comprising receiving pieces of attendant specifying data from the group of satellite communication devices, forming a set of attendant specifying data including pieces of received attendant specifying data and sending the set of attendant specifying data to the second main communication device via the network.

8. The method of claim 7, wherein the set of attendant specifying data also includes a piece of attendant specifying data associated with the first main communication device.

9. The method of claim 7, wherein a piece of attendant specifying data is an identity of the communication device associated with the local wireless interface.

10. The method of claim 7, wherein a piece of attendant specifying data is an electronic business card associated with a corresponding communication device.

11. The method of claim 1, wherein the combining also includes combining said received sound with sound picked up by the first main communication device.

12. A first main communication device provided in a first site for engaging, via a communication network, in a conference communication session with at least one second main communication device provided in a second site comprising:
a first network interface associated with the communication network,
a local wireless interface for interfacing with a number of satellite communication devices,
a network communication unit for communicating over the first network interface,
a local communication unit for communication with satellite communication devices via the local wireless interface, and
a control unit configured to
receive sound picked up by a group of satellite communication devices at said first site via said local wireless interface,
combine this received sound, and
order the network communication unit to send the combined sound via the network interface to the at least one second main communication device as sound in the conference communication session provided by the first main communication device.

13. The first main communication device of claim 12, wherein the control unit is further configured to send an invitation to join the conference communication session to satellite communication devices that are within range of the local wireless interface, receive an acceptance from a number of satellite communication devices via the local wireless interface and form said group of satellite communication devices from satellite communication devices that have accepted the invitation.

14. The first main communication device of claim 13, wherein the acceptance includes a key and the control unit is further configured to compare the received key with a conference key and form said group only of satellite communication devices that have sent a key matching the conference key.

15. The first main communication device of claim 12, wherein the control unit is further configured to distribute sound received from the second main communication device in the conference communication session to the group of satellite communication devices via the local wireless interface.

16. The first main communication device of claim 12, wherein the control unit is further configured to only combine sound from a communication device at the first site during a time interval in the conference communication session where sound above a sound pressure level threshold is picked up by said communication device.

17. The first main communication device of claim 12, wherein the control unit is further configured to receive speech indicators from satellite communication devices at the first site and to only combine sound from satellite communication devices during a time interval in the conference communication session for which a corresponding speech indicator has been received.

18. The first main communication device of claim 12, wherein the control unit is further configured to receive pieces of attendant specifying data from the group of satellite communication devices, form a set of attendant specifying data including pieces of received attendant specifying data and send the set of attendant specifying data to the second main communication device via the network interface.

19. The first main communication device of claim 18, wherein a piece of attendant specifying data is an identity of the communication device associated with the local wireless interface.

20. The first main communication device of claim 18, wherein a piece of attendant specifying data is an electronic business card associated with a corresponding communication device.

21. The first main communication device of claim 12, further comprising a sound pick-up unit and where the control unit when being configured to combine sound is configured to combine said received sound with sound picked up by the sound pick up unit.

22. The first main communication device of claim 12, wherein it is a portable communication device.

23. The first main communication device of claim 22, wherein it is a wireless communication device.

24. The first main communication device of claim 23, wherein it is cellular phone.

25. A computer program product for engaging in a conference communication session via a communication network between a first main communication device provided in a first site and at least one second main communication device provided in a second site and comprising:
computer program code on a computer readable medium, configured to make the first main communication device perform, when said program code is loaded in the first main communication device,
receive sound picked up by a group of satellite communication devices at said first site via a local wireless interface,
combine this received sound, and
order the sending of the combined sound to the at least one second main communication device via the network as sound in the conference communication session provided by the first main communication device.
